(19) United States
(12) Patent Application Publication
(10) Pub. No.: US 2009/0212937 A1
(43) Pub. Date: Aug. 27, 2009

(54) Active line termination module

(75) Inventors: Arne Stamer, Siebenbaeumen (DE); Jan Heick, Rethwisch (DE)

Correspondence Address: COLLARD & ROE, P.C., 1077 NORTHERN BOULEVARD, ROSLYN, NY, 11576, US

(73) Assignee: Minimax GmbH & Co. KG

(21) Appl. No.: 12/378,150

(22) Filed: Feb. 11, 2009

(30) Foreign Application Priority Data
Feb. 22, 2008 (EP) 08 003 270.9

(51) Int. Cl. G08B 29/00

(52) U.S. Cl. 340/506

(57) ABSTRACT

An active line termination module for monitoring a line impedance of electrical systems, particularly for use at the ends of fire alarm lines, consists of a constant current sink with lighted display, a voltage regulator, and an intelligent electronic component disposed between the lines to be monitored, so that the intelligent electronic component is connected with the constant current sink by a line.

### CROSS REFERENCE TO RELATED APPLICATIONS

Applicants claim priority under 35 U.S.C. §119 of European Application No. 08003270.9 filed Feb. 22, 2008.

### BACKGROUND OF THE INVENTION

1. Field of the Invention

The invention relates to an active line termination module for monitoring a line impedance of electrical systems.

The active line termination module is suitable for use in monitoring fire alarm lines, particularly for use in alarm sockets at the ends of fire alarm lines.

2. The Prior Art

Monitoring of limit value lines such as fire alarm lines for wire breaks and short-circuit has taken place, until now, by a monitoring current that is caused by a resistor at the end of the line. This monitoring current plus the power consumption of the fire alarm on the line forms the rest current that is continuously monitored by the central location. If this rest current drops below a specific value, the central location recognizes this as a wire break on the line and reports a problem.

More recent European standards require that an increase in the line impedance, to the value specified as a maximum, must lead to the display of a wire break message. This is very difficult using the conventional method, since a drop in rest current by approximately 0.1 mA would already have to lead to a problem report. Since the real line rest current can vary by several mA as a result of the pulsing power consumption of some alarms, it is not possible to meet the most recent standards with the conventional technology.

A method and a device for monitoring an alarm line of a fire alarm system for problems are described in European Patent No. EP 1 855 261 A1, whereby the fire alarm system has a line current applied to it in operation, and has a terminal element formed by a TVS diode. Monitoring of the line current and/or of the line voltage takes place. Problems in the alarm line are recognized by a short-term increase and a short-term drop in the line current. The evaluation takes place via the voltage levels and not via the current. The evaluation measure is carried out by the fire alarm central location, from which the raising and lowering of the line current also take place, but not by a module at the end of the fire alarm line. Because of the non-linear and temperature-dependent behavior of TVS diodes at the end of the line, it can be problematic to determine the absolute value of the line impedance, particularly if precise ranges are established. If only rough ranges can be established, this indicates a creeping wire break/short circuit, which might be difficult to recognize reliably in its very early stage.

It is furthermore disadvantageous that a range is present (approximately 50 ohms to 1,000 ohms) in which no problems are indicated, although an alarm can no longer be reliably evaluated.

### SUMMARY OF THE INVENTION

It is therefore an object of the invention to provide a monitoring module for the line termination of alarm lines, particularly fire alarm lines, that can determine wire breaks independent of voltage, and can be retrofit onto existing systems.

This task is accomplished by an active line termination module for monitoring a line impedance of electrical systems, in which a constant current sink with lighted display, a voltage regulator, and an intelligent electronic component are disposed between the lines to be monitored, so that the intelligent electronic component is connected with the constant current sink by a line. The active line termination module is suitable for monitoring lines, particularly alarm lines of any type, but particularly for monitoring lines of a fire alarm line. For this purpose, the device according to the invention can be structured mechanically in such a manner that it can be plugged into an alarm socket at the end of a fire alarm line, as a line termination. This can take place with one or more plugs. However, the active line termination module according to the invention can also be directly integrated into the circuit of an alarm system, particularly a fire alarm, and this represents an important embodiment particularly for systems to be newly built. According to this embodiment, the fire alarm can be integrated into the plug-in line termination module, or the line termination module can be connected with the fire alarm in a fixed manner, or integrated into this alarm. If the line termination module is integrated into the fire alarm, the microcontrollers present in the fire alarm can be utilized.

The constant current sink of the active line termination module is controlled, in the rest case, by an intelligent electronic component, which forms the rest current for the line to be monitored. The intelligent electronic component cyclically turns off the constant current sink for a short time, or increases the constant current and measures the voltage at the line to be monitored, before and after shut-off, or the current increase. In the case of any overly high impedance, the constant current sink is shut off and/or a signal is issued to a monitoring device. The monitoring device can represent a fire alarm or its alarm system.

It is advantageous to switch a voltage regulator ahead of the intelligent electronic component. In another advantageous embodiment, the voltage regulator can also be integrated into the intelligent component. The intelligent component can represent a microcontroller or a programmable logic component.

The lighted display, in an advantageous embodiment, can represent a light-emitting diode. If the value of the measured line impedance rises above the predetermined value, the intelligent electronic component shuts off the constant current sink, and the lighted display goes out, so that the monitoring central location registers a wire break. However, extinction of the light-emitting diode also optically shows that operation is not free of problems. It is also possible to replace the lighted display with another suitable signal emitter.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a block schematic of an active line termination module, in which the voltage regulator is integrated into the microcontroller;

FIG. 2 shows a block schematic of an active line termination module with separate voltage regulator and microcontroller;

FIG. 3 shows an active line termination module with lines and plug-in connections for an alarm socket;

FIG. 4 shows an active line termination module integrated into the circuit of a fire alarm;

FIG. 5 shows an active line termination module integrated into the circuit of a fire alarm, whereby the voltage regulator is integrated into the microcontroller; and

FIG. 6 shows an active line termination module integrated into the circuit of a fire alarm.

### DETAILED DESCRIPTION OF THE PREFERRED EMBODIMENT

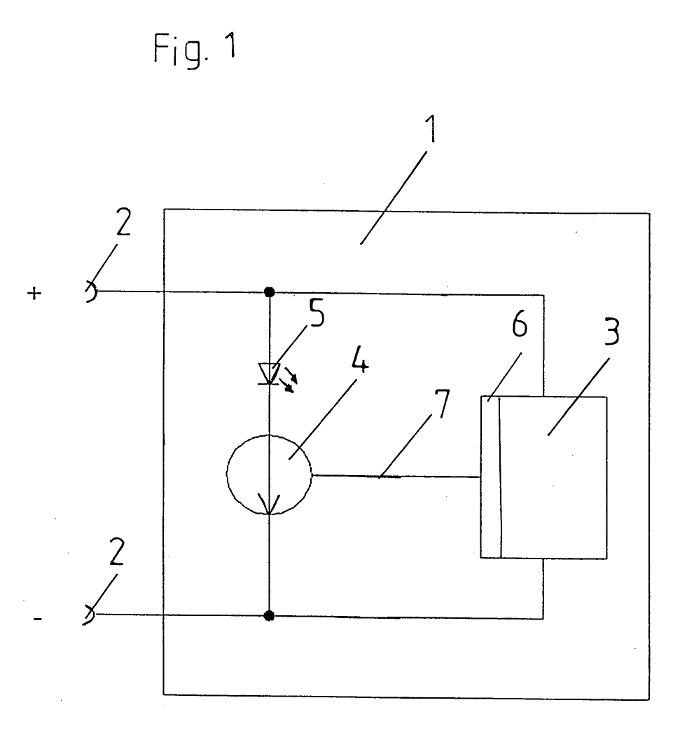

Referring now in detail to the drawings and, in particular, FIG. 1 shows the block schematic of an active line termination module 1, which can be plugged onto the line to be monitored with contacts 2.

Light-emitting diode 5 and constant current sink 4 are disposed between the positive and the negative electrical contact 2, and connected with one another by lines. Parallel to this, a microcontroller 3 having a voltage regulator 6 is disposed as an intelligent electronic component. A line 7 runs from microcontroller 3 to constant current sink 4. Constant current sink 4 is turned on by microcontroller 3 in the rest case, and forms the rest current for the line to be monitored. Microcontroller 3 cyclically switches constant current sink 4 off for a short time and/or increases the constant current for a short time, and measures the voltage on the line before and after this shut-off or current increase, respectively. The difference of these two values is directly proportional to the line impedance of the line to be monitored. If the value of the measured line impedance increases above the predetermined value, the microcontroller 3 shuts off constant current sink 4, and light-emitting diode 5 goes out, so that the monitoring central location registers a wire break. However, extinction of the LED is also an optical display indicating non-problem-free operation.

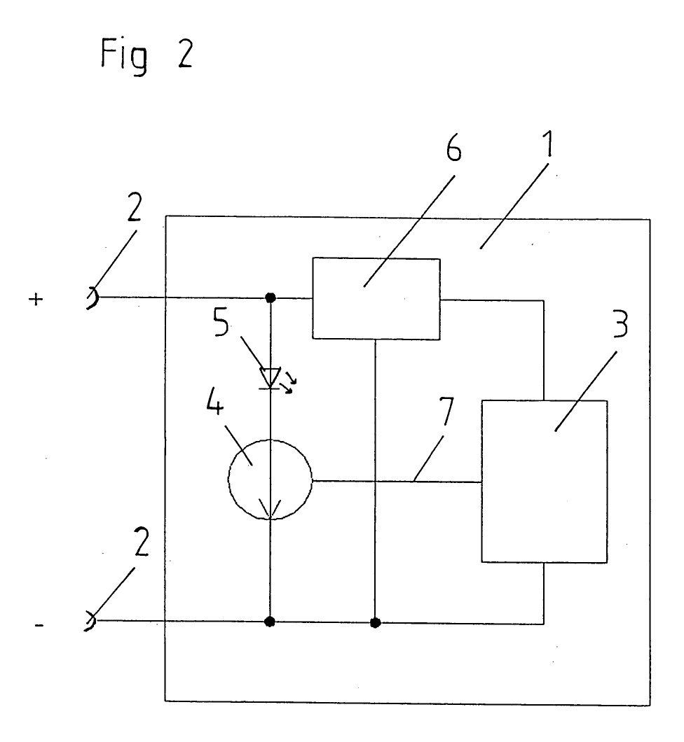

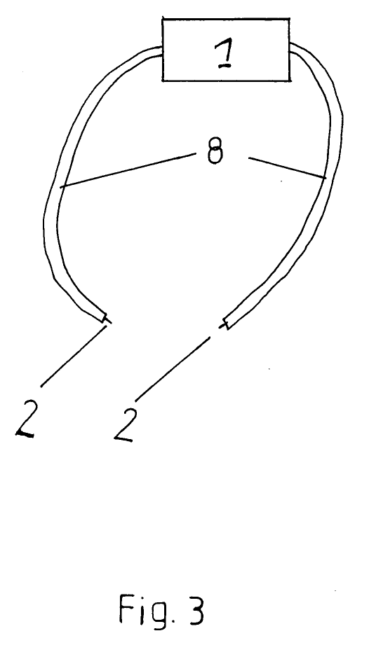

The embodiment shown in FIG. 2 provides for disposing voltage regulator 6 ahead of microcontroller 3. FIG. 3 shows active line termination module 1 that can contain the circuits of FIG. 1 or FIG. 2, from which lines 8 lead to contacts 2. Active line termination module 1 can be plugged into the alarm socket, for example a fire alarm line, with these contacts 2, so that the latter line can be continuously checked. The lighted display in the active line termination module indicates problem-free operation or a wire break.

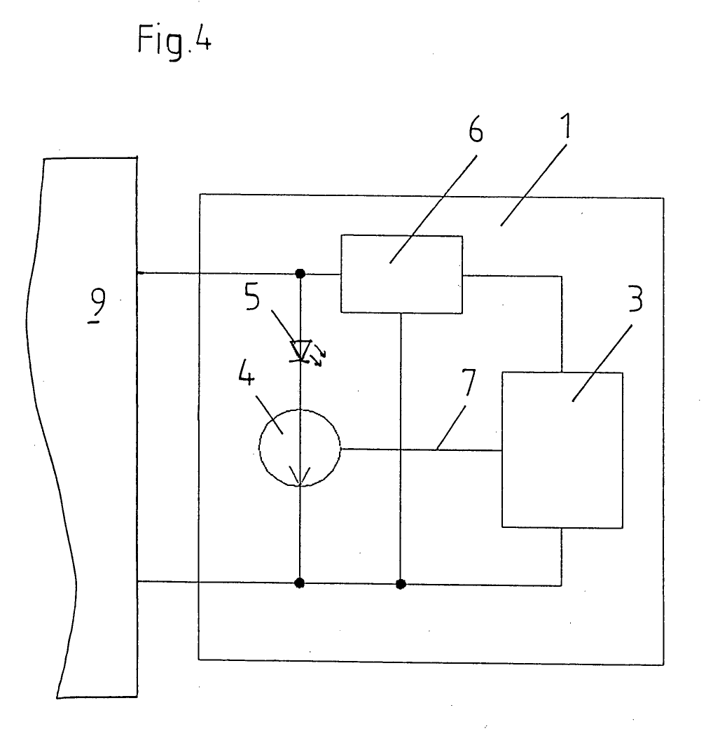

In FIG. 4, an embodiment is shown in which active line termination module 1 is integrated into the circuit of a fire alarm 9, and voltage regulator 6 is switched ahead of microcontroller 3.

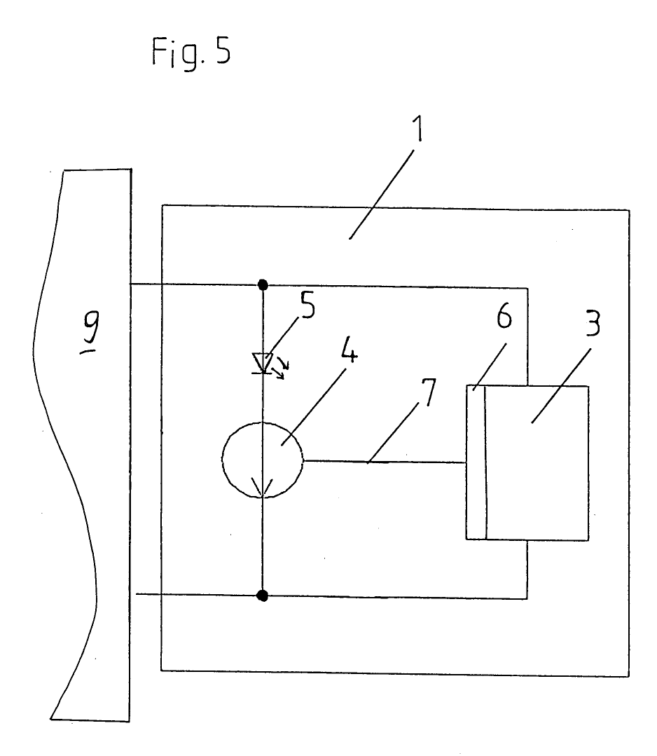

FIG. 5 shows an embodiment in which active line termination module 1 is integrated into the circuit of fire alarm 9, and voltage regulator 6 is integrated into microcontroller 3.

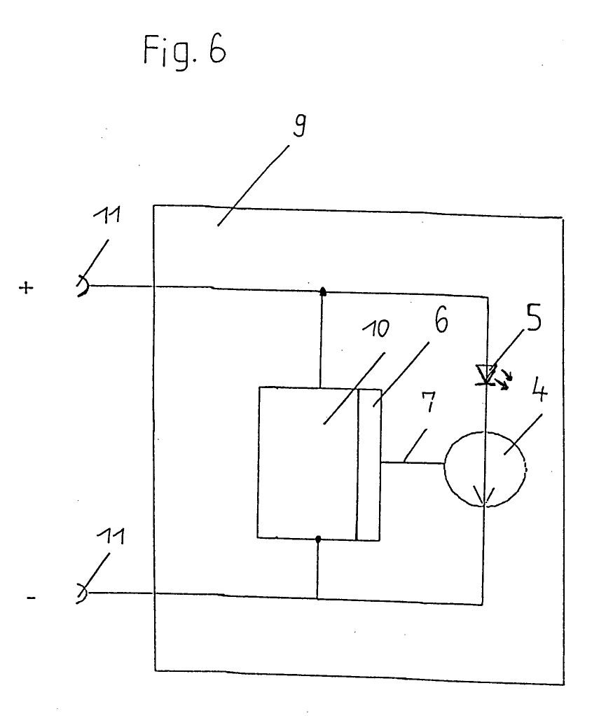

FIG. 6 shows an embodiment in which microcontroller 10 of fire alarm 9 is connected with a constant current sink 4 and light-emitting diode 5, and thereby a fire alarm having an integrated line termination module is formed. The device represents a variant of FIG. 5, whereby microcontroller 3, 10 does not have to be present twice in fire alarm 9 and line termination module 1, since microcontroller 10 of the fire alarm takes over control of constant current sink 4.

Contacts 11 of fire alarm 9 to the fire alarm line to be monitored are not necessarily configured so that they can be plugged in. They can also be configured as screw terminals, etc.

The invention can be produced to be mechanically compatible with the conventional connection resistor, so that it is possible to retrofit existing systems. By means of its use, the system reliability is increased by problem reports when the permissible line impedance is exceeded, so that problems are indicated in all resistance ranges. The rest current of the fire alarm lines is voltage-independent because of the constant current sink, thereby increasing the reliability in the evaluation of the line current by the fire alarm central location. Furthermore, an optical display for problem-free operation takes place by the lighted display.

Accordingly, while only a few embodiments of the present invention have been shown and described, it is obvious that many changes and modifications may be made thereunto without departing from the spirit and scope of the invention.

### LIST OF REFERENCE SYMBOLS USED

1 active line termination module
2 contact of the active line termination module to be monitored
3 microcontroller
4 constant current sink
5 light-emitting diode
6 voltage regulator
7 lines between 3 and 4
8 lines from the active line termination module 1 to the contact 2
9 circuit of a fire alarm
10 microcontroller of the fire alarm
11 contact of the fire alarm with the fire alarm line to be monitored

What is claimed is:

1. An active line termination module for monitoring impedance of a line in an electrical system, comprising:
a constant current sink with lighted display;
a voltage regulator; and
an intelligent electronic component connected with the constant current sink by a line;
wherein the constant current sink, voltage regulator and intelligent electronic component are adapted to be connected to the line to be monitored;
wherein the active line module is adapted to lower a line current at an end of the line to be monitored;
wherein the constant current sink in a rest case is turned on by the intelligent electronic component and forms a rest current for the line to be monitored;
wherein the voltage regulator is adapted to keep a voltage of the line to be monitored constant and the intelligent electronic component is adapted to cyclically turn off the constant current sink for a short time, or increase the current, and;
wherein the module measures the voltage on the line to be monitored before and after the constant current sink is turned off or the current is increased, and in the case of an overly high impedance, shuts off the constant current sink or issues a signal to a monitoring device.

2. The active line termination module according to claim 1, wherein the line to be monitored is a fire alarm line.

3. The active line termination module according to claim 2, wherein the voltage regulator is switched ahead of the intelligent electronic component.

4. The active line termination module according to claim 3, wherein the voltage regulator is integrated into the intelligent component.

5. The active line termination module according to claim 3, wherein the intelligent component is a microcontroller or a programmable logic component.

6. The active line termination module according to claim 5, wherein the lighted display is a light-emitting diode.

7. The active line termination module according to claim 6, wherein the active line termination module has contacts adapted to be plugged into an alarm socket of a fire alarm line.

8. The active line termination module according to claim 6, wherein the active line termination module is integrated into a circuit of a fire alarm.

9. The active line termination module according to claim 6, wherein a fire alarm and the line termination module are adapted to be plugged into an alarm socket of the fire alarm line.
